(19) United States
(12) Patent Application Publication
(10) Pub. No.: US 2011/0145119 A1
(43) Pub. Date: Jun. 16, 2011

(54) METHOD FOR STANDARDIZING AND OPTIMIZING FINANCIAL SERVICES WITH THE USE OF ELECTRONIC DATA PROCESSING

(76) Inventors: Eugen Bucher, Bammental (DE); Jörg Jacob, Burgwedel (DE)

(21) Appl. No.: 12/964,251

(22) Filed: Dec. 9, 2010

(30) Foreign Application Priority Data
Dec. 10, 2009 (DE) 10 2009 057 488.3

(51) Int. Cl. G06Q 40/00

(52) U.S. Cl. 705/35

(57) ABSTRACT

A method for standardizing and optimizing financial services with the use of electronic data processing, wherein the personal data of a customer is collected according to a predefined, harmonized data acquisition system, and taking as a basis the scientific findings and the set of standards derived from these scientific findings, the personal requirements are determined in a repeatable manner by means of a computer program, and wherein a needs-based recommendation that is backed by scientific findings is displayed in writing and/or graphically on a display and/or is printed out by a printer.

### CROSS-REFERENCE TO RELATED APPLICATIONS

The present application claims priority from German Patent Application No. 10 2009 057 488.3-53, filed Dec. 10, 2009.

### BACKGROUND OF THE INVENTION

The invention relates to a method for standardizing and optimizing financial services with the use of electronic data processing.

### FIELD OF THE INVENTION

To date it has been customary to provide financial services on the basis of the individual experience of a consultant. If the consultant is a dependent consultant for example, of a specific insurance company or a bank, then the advice is based solely on the services offered by the respective business enterprise. This service may not be acceptable to the customer.

Even the advice of an independent financial consultant is problematic, because to date there are no standards whatsoever for the financial consulting process. As a consequence, the results of the consulting process of different consultants vary widely, even if otherwise the requisite neutrality of the consultant is guaranteed. This difference is due to the fact that the financial advice is not even based on a uniform data acquisition concept. Moreover, the consultant usually relies on his own estimation, a strategy that results in a consulting process and ultimately also a sales process that varies widely from consultant to consultant. Therefore, a customer has to assume that he will obtain very different, that is, individual, recommendations as a function of the respective financial consultant and that these recommendations will be unrelated to a systematically coordinated consulting and planning concept.

In other words, the quality of the advice in the financial service sector depends on the expertise and due diligence of the respective consultant. In addition, the consultant is always subject to the risk of giving wrong advice unintentionally, that is, owing to the lack of all-inclusive competence.

Finally the consulting process requires that the individual devote a lot of time to the process, so that the result of the consulting process is always distinctly subjective.

In light of the above statements, the object of the invention is to provide a method that is intended for standardizing and optimizing the financial services and that uses existing technological facts and conditions, that is, at variance with the procedure based solely on the specialized trade knowledge of the consultant. In this case the invention uses electronic data processing, that is, subject to the standardization and optimization of the financial services, as a result of which, it will be possible for the first time to reconstruct how the results of the consulting process were generated.

In detail, the personal data of a customer are collected not, for example, according to an individual list, but rather according to a harmonized data acquisition system. For this purpose a standardized risk questionnaire is used that is supplemented with the information concerning the customer's existing contracts and policies.

Taking as a basis the scientific findings and the set of standards derived from these scientific findings, the result is a so-called segment finding software, in which the standards and priorities for the personal requirements of the customer are integrated. With the application of electronic data processing, that is, with the application of the computer program that contains the set of standards, the personal requirements are determined in a repeatable manner. In this respect a needs-based recommendation that is backed by scientific findings is displayed in writing and/or graphically on a display and/or is printed out by a printer.

The consulting process is formalized in an inventive way, that is, on the basis of the actual data that are determined. These data may be optionally conditioned and fed to the computer program containing the set of standards for further processing. Personal nuances of the consultant or even manipulations with respect to the results of the consulting process are ruled out.

Derived from the legal bases, the set of standards determines the personal priorities, and in particular as a function of the customer situation that is defined and/or determined beforehand.

For the purposes of data collection, a printed data acquisition mask or an interactive data acquisition mask is made available on a display in an advantageous manner. In this case it is expedient for the consultant to use uniformly equipped notebooks that are clearly either decentralized data acquisition/computing units or that have access to a central computer by way, for example, of UMTS or directly by way of the Internet. In any event the personal data relating to the customer are acquired. The data acquisition mask is obviously at least to some extent a standardized risk questionnaire, into which the existing contracts and policies can be simultaneously fed.

The determined data, that is, the actual state, are acquired, buffered and then fed from there—optionally conditioned—to the computer program containing the set of standards for the data analysis and evaluation. This process cannot be influenced by the consultant.

The above explained procedure that can be reconstructed with the computer predominantly helps to prevent any misunderstandings during the consulting process.

Moreover, it is especially important that the data acquisition system and/or the results of the data analysis and/or the results of the evaluation comprise a plurality of resource intensive service fields, which only then makes it possible at all to carry out a needs-based and totally uniform consulting process that is based on standards and priorities and, thus, on recommendations that are based on scientific findings.

The set of standards is based on six resource intensive service fields that are included in the financial consulting process. Between the resource intensive service fields there is an interdependence that the set of standards considers in a unique manner, based on scientific findings.

There are in total six resource intensive service fields that comprise the topics “ensure health,” “ensure income,” “protect assets,” “old age pension,” “house and family” and “capital formation/assets optimization.” These resource intensive service fields dominate the composition of the set of standards.

Each resource intensive service field comprises in turn several segments. Preferably the resource intensive service fields are assigned—altogether—37 segments/subsegments.

Ensure income includes
a. sick day pay, occupational disability, basic ability, dread disease, nursing, accident, temporary life insurance.

Ensure health includes
a. compulsory health insurance, private full coverage health insurance, private supplemental health insurance as well as foreign health insurance.

Old age pension includes
a. basic pension, bonus pension, company pension plan, old age insurance (classic/funds-linked) and life insurance (classic/funds-linked).

Home and family include
a. savings for home building purposes, financing of suitable objects, security provided for children, investment funds (income producing real property), investment funds (capital for children) and real property for own use.

Assets formation/assets optimization include
a. capital forming benefits, investment funds, savings for home building purposes, assets management, share holdings, and rented real property.

Finally protect assets includes
a. liability, household goods, motor vehicle, legal protection, residence, travel luggage and glass.

In order to apply the set of standards, it has been recognized that the resource intensive service fields and, thus, the segments are at least partially dependent on each other. The results are the crosslinks between the resource intensive service fields and, thus, also between the segments. It is important that given a specified budget and/or liquidity and taking into consideration the individual situation in each case, a specific requirement can be determined and/or covered.

In this case the resource intensive service fields and the associated segments interact. The consideration of such an interaction is based on the pertinent scientific findings that are integrated into the set of standards and/or the computer program mapping the set of standards.

In the case study of a person who is, for example, single, a so-called action matrix can be defined, according to which the set of standards assigns the current status to the segments of the respective resource intensive service fields. The degree of goal attainment is displayed. Similarly, any gaps, necessary expenditures and/or contributions or savings installments and optionally a weighting are displayed.

The set of standards generates in an additionally advantageous manner a recommendation, in particular taking into consideration the individual budget and liquidity of the respective person.

Moreover, the set of standards is appropriate for suggesting individual solutions. Possible savings are displayed. The same also applies to necessary contributions and/or savings installments in order to close the indicated gaps. They are calculated in detail in an additionally advantageous way. It is also conceivable that the invested monthly contribution or the monthly contribution that is to be invested is displayed as a function of the targeted goal attainment. It is also possible to name an invested monthly savings installment or a monthly savings installment that is to be invested.

Within the framework of a visualization that is to be generated it is especially advantageous to configure this visualization using the simplest kind of graphics, for example, using bar graphs.

In an especially highly advantageous manner the set of standards generates a graduated plan, according to which the first step performs the optimization for the personal minimum. In a second step an optimization for maintaining the standard of living takes place. A third step optimizes for a rise in the standard of living. Finally in a fourth step an optimization for an increase in net worth and for assets protection takes place. At the same time the horizon for this fourth step must be regarded as long term.

Finally it is conceivable that the computer program containing the set of standards outputs a clear and unambiguous recommendation, as far as proposing one or more products, with or without reference to a very specific product provider. In this case, too, it is possible to perform a more extensive optimization, that is, within the framework of a subsequent ranking that is adjusted on a regular basis to the actual conditions of the market through on-line access to pertinent databases. The recommendation can be based on a quality standard that is ranked below the actual set of standards.

### BRIEF DESCRIPTION OF THE SEVERAL VIEWS OF THE DRAWINGS

At this point there are various options for configuring and further developing in an advantageous way the teaching of the present invention. For this purpose reference is made, on the one hand, to the various other embodiments and, on the other hand, to the following description of a preferred embodiment of the inventive method in conjunction with the drawings. In addition, generally preferred embodiments and further developments of the teaching are described in conjunction with the description of the preferred embodiment of the invention with reference to the drawings. In the drawings

FIG. 1 is a schematic drawing, depicting the six resource intensive service fields underlying the method of the invention and the set of standards that are used there.

FIG. 2 is a schematic drawing, depicting the interaction between the six resource intensive service fields, based on the liquidity and subject to the standards and priorities.

FIG. 3 is a schematic drawing, depicting the six resource intensive service fields and a total of 37 subsegments, and

FIGS. 4 a/b are schematic drawings, depicting an action matrix that comprises a total of four steps with a number of goals.

### DETAILED DESCRIPTION

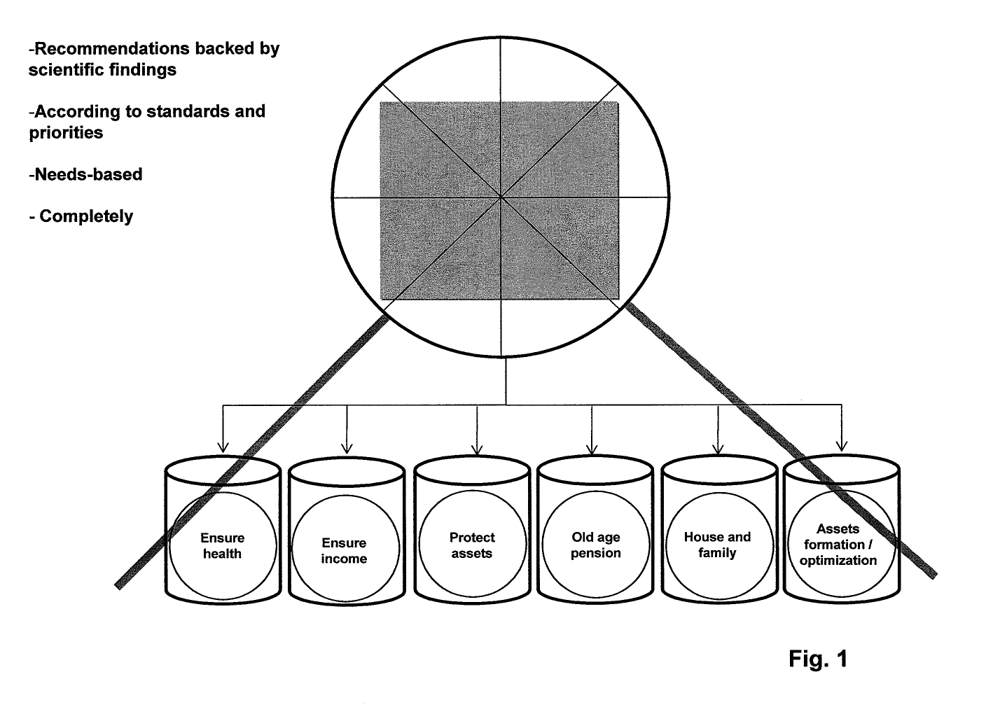

FIG. 1 is a schematic drawing, depicting the resource intensive service fields that underlie the method of the invention. These resource intensive service fields interact and are based on a standardized risk questionnaire. The segment finding software that processes the data comprises a set of standards that is based on substantiated scientific findings and that knows the standards and priorities. The priorities are derived from the respective personal customer situation and are ultimately derived from the legal bases.

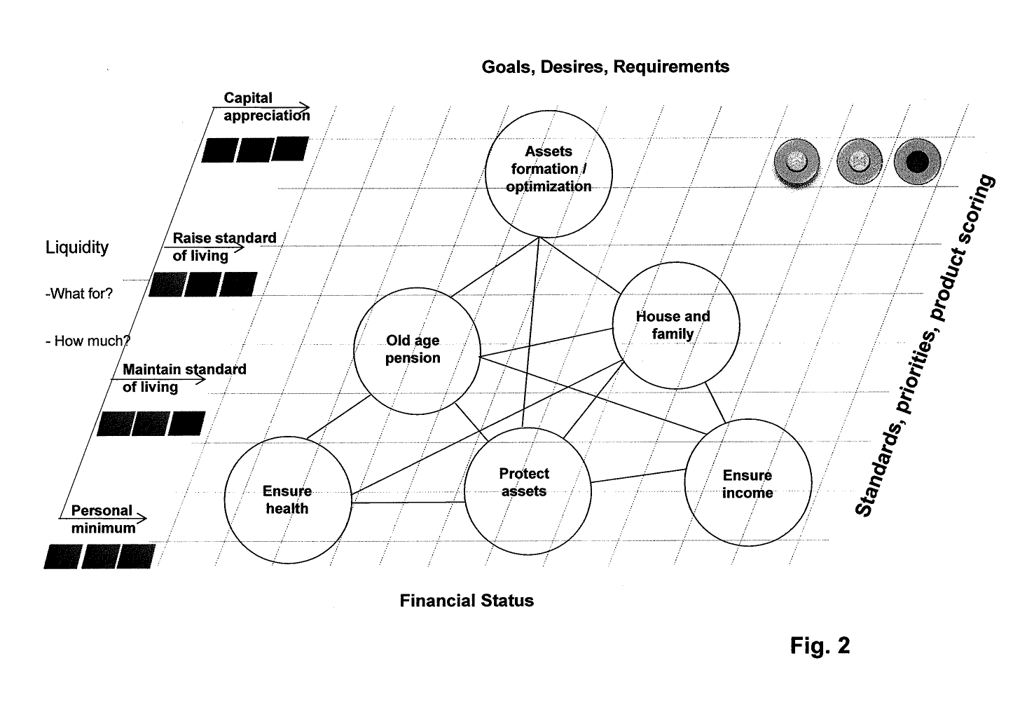

The drawing in FIG. 2 depicts on the left side the steps to reach the targeted goal attainment and the interaction between the resource intensive service fields and the segments contained in said fields. Goals, desires and requirements can be taken as a basis. A recommendation is based on standards and priorities.

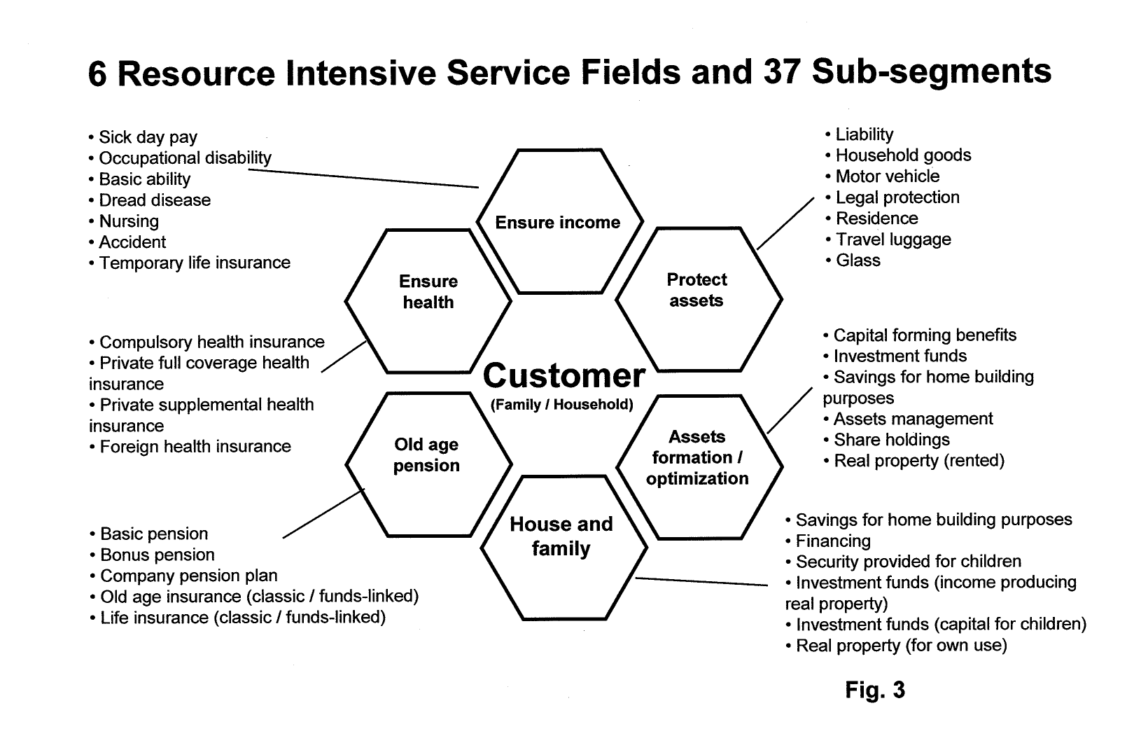

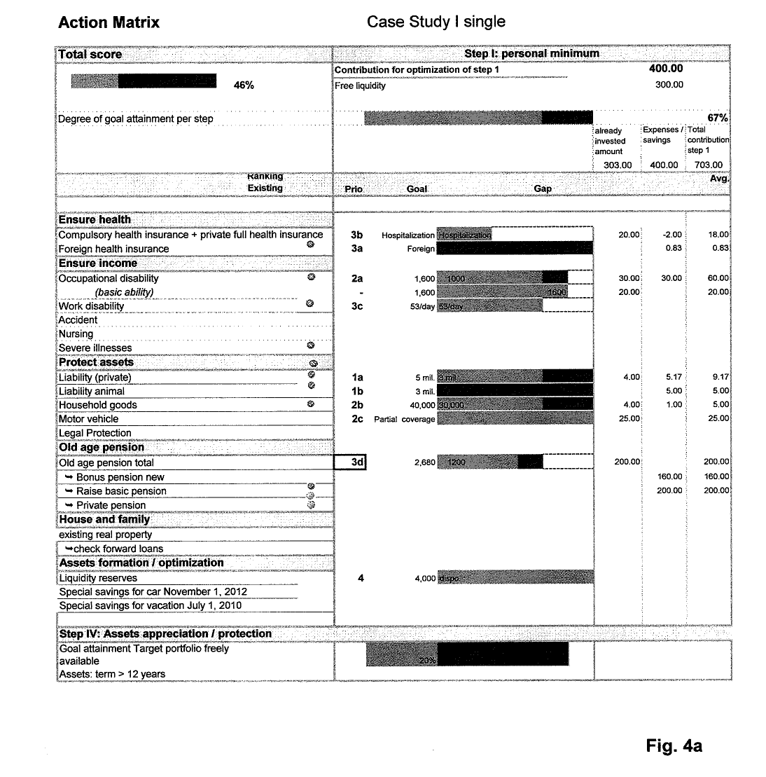

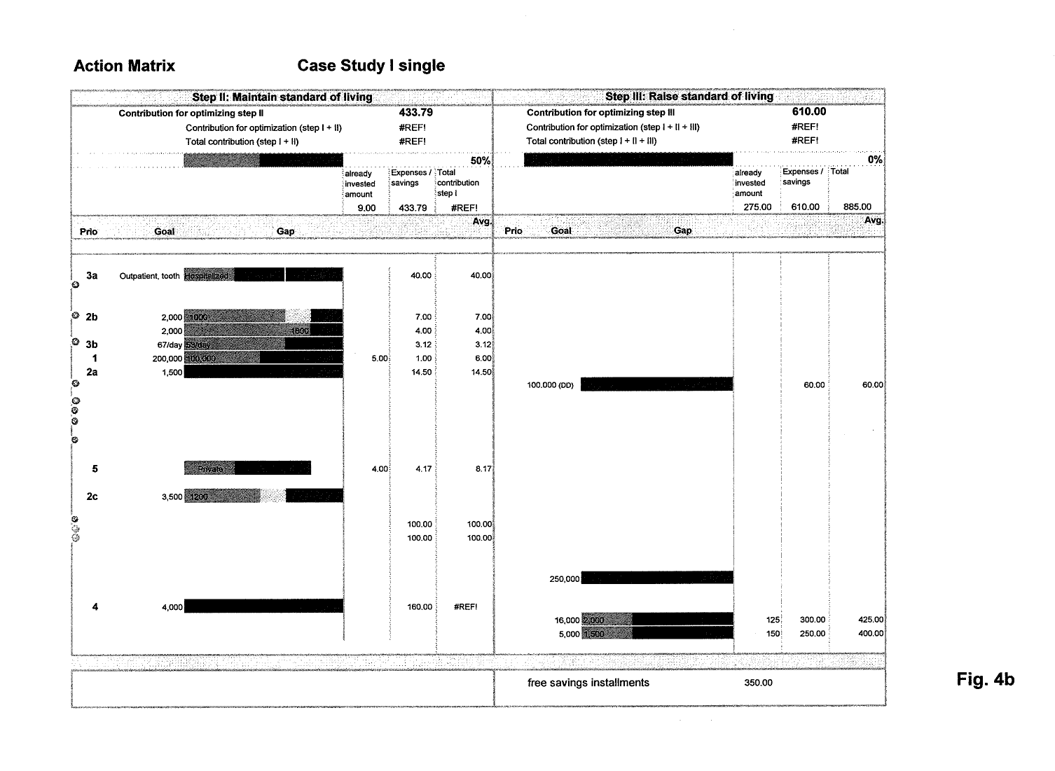

FIG. 3 is a schematic drawing, depicting the six resource intensive service fields that comprise a total of 37 subsegments. Recommendations are outputted on the segment level. A product is selected according to a predefined logic, taking into consideration the relevant performance features.

Taking into consideration the individual desires, the requirement can be re-calculated. In this respect it is important that the customer's request can water down a pre-set standard in a documented way, so that it is documented in a reconstructable manner.

At this point it must be noted once again that the method according to the invention is based on a harmonized concept that starts with a harmonized data collection, that is, with a standardized data collection. The data acquisition mask records all individual data and/or the actual data and feeds said data into the system as the mandatory data.

Then an analysis and/or interpretation takes place on the basis of the set of standards that considers the resource intensive service fields and, thus, the topics.

Subject to the application of the set of standards, a standardized result is outputted, that is, on the basis of an iterative process of an approximation approach to a solution.

An interdependence between the various topics and/or resource intensive service fields is considered in the segments. In any event when the resource intensive service fields are calculated, an iterative process takes place.

The relevant segments are selected by means of a computer logic program. On finding the segment, a product is then selected. Finally the consultant gives a recommendation on the basis of the program determined data.

The method according to the invention makes possible a semi-automated consulting process on the basis of standards and priorities, in the final end on the basis of scientific findings. The segment finding software outputs a segment, and then a market comparison can take place by means of follow-up software. Scientific theories are always tied in, so that the basic needs of humans are considered as a matter of fact.

The segment finding software considers the personal minimum of each person to be covered. Proceeding on this strategy, an action matrix is determined. The segment finding software delivers a recommendation to the customer that accounts for each of the resource intensive service fields in the respective steps of the targeted goal attainment. One step after the other is processed in sequence. Priorities with respect to order of sequence and intensity of need are taken into consideration.

Once again it must be emphasized that a type of automation of the consulting process occurs with the set of standards. In particular, it is especially important that the priorities in the segments change at each step of the individual requirement. This change can be ascribed to the fact that the evaluation criteria are dynamic and configured individually for each step. The key factor is the available liquidity, on which is based a recommendation for the correct order of sequence to distribute the liquid funds.

Once the actual segment has been found, there are additional questions concerning the product to be recommended by the consultant. In this case, the process can be further automated, that is, for example, taking into consideration the published criteria of consumer protection organizations, etc.

In this case, too, the product provider, that is, the company, and the respective relevant fee can be ranked, and the customer can be given a recommendation on the basis of this ranking. In this case, too, automation is possible—under certain conditions.

Furthermore, it is particularly very important that a consulting protocol can be prepared in an automated manner in accordance with the method, according to which both the consultant and also the customer can reconstruct how the results of the consulting process and the outputted recommendation were produced. Above all, the customer can reconstruct the underlying data.

In order to avoid repetitions, reference is made to the section of the description that contains the general information.

In summary it must be pointed out explicitly that the above described embodiment of the method according to the invention serves only to explain the claimed teaching, but is not intended to restrict this teaching to the embodiment.

What is claimed is:

1. A method for standardizing and optimizing financial services with the use of electronic data processing, said method comprising:
collecting personal data of a customer according to a predefined, harmonized data acquisition system;
taking as a basis the scientific findings and the set of standards derived from these scientific findings; and
determining personal requirements in a repeatable manner by means of a computer program,
wherein a needs-based recommendation that is backed by scientific findings is displayed in writing and/or graphically on a display and/or is printed out by a printer.

2. The method as claimed in claim 1, wherein a printed data acquisition mask or interactive data acquisition mask is made available by means of a display for the purpose of the data acquisition.

3. The method as claimed in claim 1, wherein the collected data is fed into a database and from there into a computer program, containing the set of standards, for the purpose of the data analysis and evaluation.

4. The method as claimed in claim 3, wherein the data acquisition system and/or the results of the data analysis and/or evaluation comprise a plurality of resource intensive service fields.

5. The method as claimed in claim 4, wherein altogether six resource intensive service fields are allowed.

6. The method as claimed in claim 4, wherein the resource intensive service fields comprise
ensure health
ensure income
protect assets
old age pension
house and family and
capital formation/assets optimization.

7. The method as claimed in claim 4, wherein each resource intensive service field comprises at least two, preferably several, segments.

8. The method as claimed in claim 7, wherein the segments comprise the topics
compulsory health insurance and private health insurance (ensure health),
occupational disability, work disability, accident, nursing, severe illness (ensure income).
liability (private), liability animal, household goods, motor vehicle, legal protection (protect assets),
old age pension in total, bonus pension new, increase basic pension, private pension (old age pension),
existing real property, check forward loans (house and family) and
liquid reserves, special savings for a motor vehicle Nov. 1, 2010, special savings for vacation Jul. 1, 2010 (capital formation/optimization).

9. The method as claimed in claim 7, wherein the resource intensive service fields and, thus, the segments are at least partially dependent on each other.

10. The method as claimed in claim 7, wherein the set of standards assigns the current status to the segments of the respective resource intensive service fields, in particular it assigns the degree of goal attainment, any gaps, necessary expenditures and/or contributions or savings installments and optionally a weighting.

11. The method as claimed in claim 1, wherein the set of standards generates a recommendation, in particular taking into consideration the budget and/or the free liquidity of the respective person.

12. The method as claimed in claim 1, wherein the set of standards suggests solutions and/or displays possible savings and/or calculates the necessary contributions and/or savings installments in order to close the indicated gaps and/or names an invested monthly contribution and/or an invested monthly savings installment.

13. The method as claimed in claim 1, wherein the set of standards generates a graduated plan, according to which
a first step performs an optimization for the personal minimum, where
a second step performs an optimization for maintaining the standard of living, and where
a third step performs an optimization for a rise in the standard of living, and where
a fourth step performs an optimization for an increase in net worth and for assets protection.

14. The method as claimed in claim 13, wherein each subsequent step considers the attainment or non-attainment of the goal of a preceding step.

15. The method as claimed in claim 1, wherein with respect to the determined need to take action, a product recommendation is generated, preferably automatically.

16. The method as claimed in claim 1, wherein the entire consulting process, including the application of the set of standards, is recorded in a reconstructable manner, stored and optionally visualized and printed out.

17. The method as claimed in claim 1, wherein the computer software comprising the set of standards comprises a mode for the individual adaptation and/or for the consideration of the customer's wishes with respect to the resource intensive service fields and/or segments.
